(19) United States
(12) Patent Application Publication
(10) Pub. No.: US 2017/0301172 A1
(43) Pub. Date: Oct. 19, 2017

(54) Remote Cage Vending System

(71) Applicant: Terry D. Suellentrop, Oklahoma City, OK (US)

(72) Inventor: Terry D. Suellentrop, Oklahoma City, OK (US)

(21) Appl. No.: 15/099,655

(22) Filed: Apr. 15, 2016

(51) Int. Cl. G07F 11/00

(52) U.S. Cl. CPC G07F 11/002

(57) ABSTRACT

An apparatus for dispensing articles to a user comprising an cage having walls defining a hollow interior with one wall having a door with a locking mechanism for automatically engaging the lock; an cage electronic module having a power source, an cage communication means to communicate with a remote monitoring device, a camera, an cage interface for receiving user inputs, an cage notification means and a remote locking system; and a remote monitoring device communicating with the cage electronic module having a power supply, a remote communication means , a visual display for receiving video from an cage camera, a remote device interface for receiving attendant inputs, a remote notification means, whereby, a user can notify an attendant after payment, to dispense articles from an cage, while attendant remotely visually monitors and opens the cage allowing a user to retrieve the purchased articles, after which the lock automatically re-engages.

### CROSS-REFERENCE TO RELATED APPLICATIONS

None

### FIELD OF THE INVENTION

The invention generally relates to remotely selling and delivering articles. In particular, the invention relates to a remote cage vending system, wherein the remote vending cage is typically placed outside of the store, and the remote cage system allows an attendant to remotely communicate with a customer and to accomplish objectives including selecting, paying, and receiving delivery of a desired article such as a filled propane tank without the attendant having to leave the store.

### BACKGROUND

Most convenient stores and grocery stores keep articles outside their buildings due to the size or the safety hazards involved. For example, propane tanks are typically stored outside due to the explosion hazard involved and also for their sheer size and bulkiness. Additionally, firewood and ice are also typically stored outside the building. In the case of propane, the new and used tanks are locked in a cage to prevent theft. The ice is typically stored in a cage refrigerator and firewood is typically stacked outside the building.

For the articles that are stored in cage s, these cage are typically locked with a padlock that requires an attendant to leave the store to escort the customer to the cage and unlock the cage and deliver the article to the customer. As for articles such as firewood these articles are left to in the open thus subject to theft. In a store that has multiple attendants, having one attendant assist a customer, may not be an issue generally, but as the store becomes busier then assisting customer with outside articles becomes more problematic. This problem becomes more apparent when in the context of a convenient store where there is only one attendant to service customers. The attendant must leave the interior of the store to assist one customer thus leaving the articles in the store more subject to theft than they would otherwise be with an attendant present.

Additionally, the current system makes the attendant more susceptible to other crimes that take place at night such as robbery and assault by luring them outside the store where they cannot immediately contact the police for help. These current situations described above may be prevented with a remote cage vending system wherein the attendant could remotely assist with the purchase and dispensing of articles outside the store while simultaneously provided theft protection for the outside articles.

### SUMMARY OF THE INVENTION

The present invention overcomes these shortcomings by providing a system that allows an attendant to service both the customers inside the store and outside the store almost simultaneously without the need for the attendant to exit the store to open the cage. The present invention also allows the attendant to perform their duties away from the service counter and still service a customer who wants an article from outside. The system allows an attendant to receive payment and remotely dispense articles outside from a secured cage thus reducing the opportunity for theft. The system utilizes a securable cage that may be remotely unlocked upon two-way communication between the customer and the attendant via remote monitor device and a cage electronic module.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a diagrammatic representation of one embodiment of the remote cage vending system using a wireless networked system.

FIG. 2 is a perspective view of a remote vending cage.

FIG. 3 is a front view of a remote vending cage door.

FIG. 4 is a rear view of the remote vending cage door.

FIG. 5 is a front view of a remote vending cage with the door fully opened.

FIG. 6 is a right side view of a remote vending cage.

FIG. 7 is a left side view of a remote vending cage.

FIG. 8 is a cross-sectional left side view of a remote vending cage with insulation installed.

FIG. 9 is a rear view of a remote vending cage.

FIG. 10 is a view of a remote monitor device in a charging stand.

FIG. 11 is a detailed view of a remote monitor device.

FIG. 12 is a detailed view of a cage electronic module.

### DETAILED DESCRIPTION OF THE INVENTION

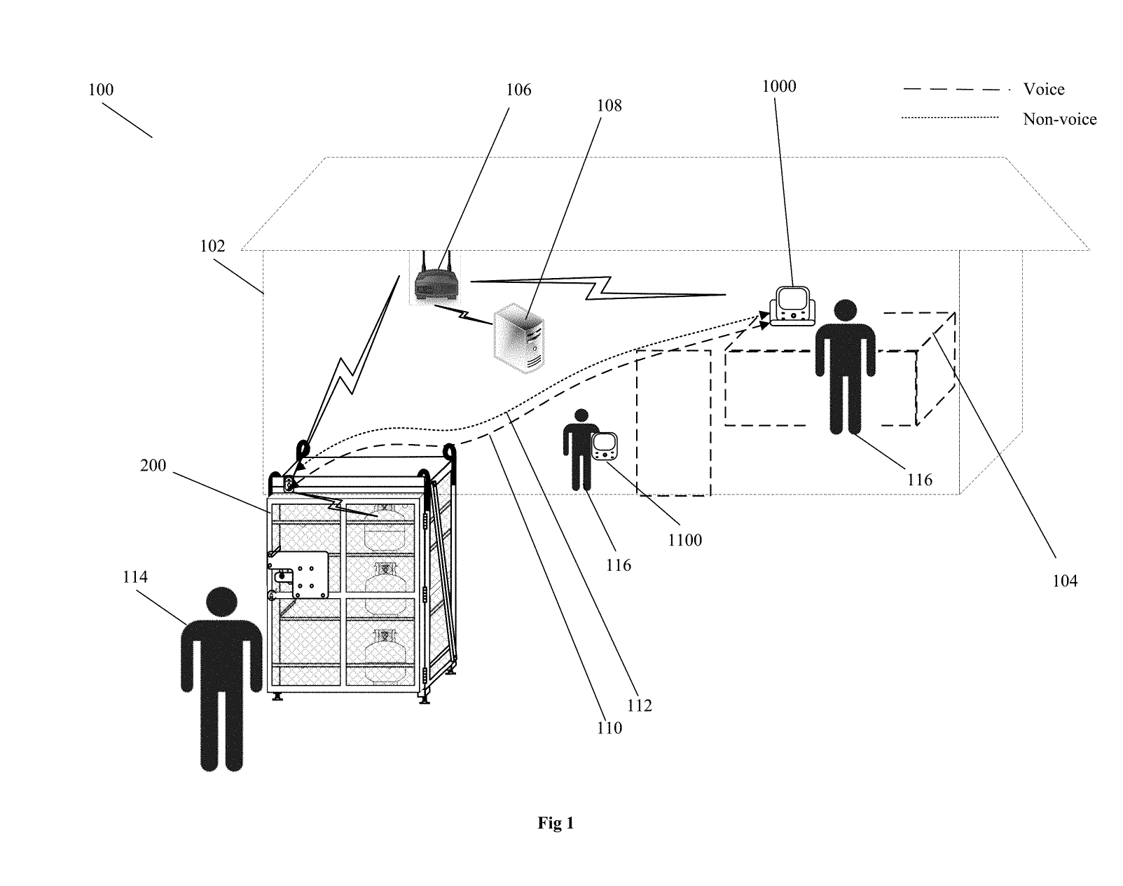

FIG. 1 is a diagrammatic representation of one embodiment of a system 100 according to the present invention. This embodiment may include a structure 102, an cage referred to hereinafter as “remote vending cage” 200, a remote monitor device system 1000, a service counter 104, a wireless router 106, a system server 108, a wireless voice communication path 110, a wireless non-voice communication path 112, a customer 114, and an attendant 116. Other embodiments may include wired, and hybrid networks.

The remote cage vending system 100 allows an attendant 116 to remotely receive an empty article and dispense a new article to a customer 114 after purchase and visually verify the transaction without the attendant 116 leaving the structure 102 unattended and a customer 114 bringing the article inside the structure 102. This improves the overall safety when the article is an empty propane tank 504. Additionally, a remote cage vending system 100 may be used without an empty article such as bundle of wood for a fireplace wherein the article would need to be secured to prevent theft but does not have a replacement.

In one embodiment the remote cage vending system 100 allows a customer 114 to enter the structure 102, typically a business such as a convenience store, approach the attendant 116 at the service counter 104 to purchase a replacement propane tank 504. Upon purchase of the tank 504, the customer 114 would exit the door, typically go to their vehicle, retrieve an empty propane tank 504 and appear in front of the remote vending cage 200 where they could be seen through a cage electronic module 1200. The customer 114 would press the call button 1222 on the cage electronic module 1200 to notify the attendant 116 that the customer 114 is at the remote vending cage 200 and they are ready to exchange their propane tank 504. Upon this notification, the attendant 116 could view the customer 114 at the remote vending cage 200 through a remote monitor device 1100. The attendant 116 may also speak to the customer 114 to verify that they had the empty propane tank 504 to exchange for a full propane tank 504 they will be removing from the remote vending cage 200. Once notification is received by the attendant 116 and they verify the customer 114 has paid then the attendant 116 may remotely unlock the remote vending cage 200 to allow access by the customer 114 to remove and exchange a propane tank 504. This prevents the structure 102 from being unattended and alleviates the attendant 116 delaying service to other customers within the structure 102.

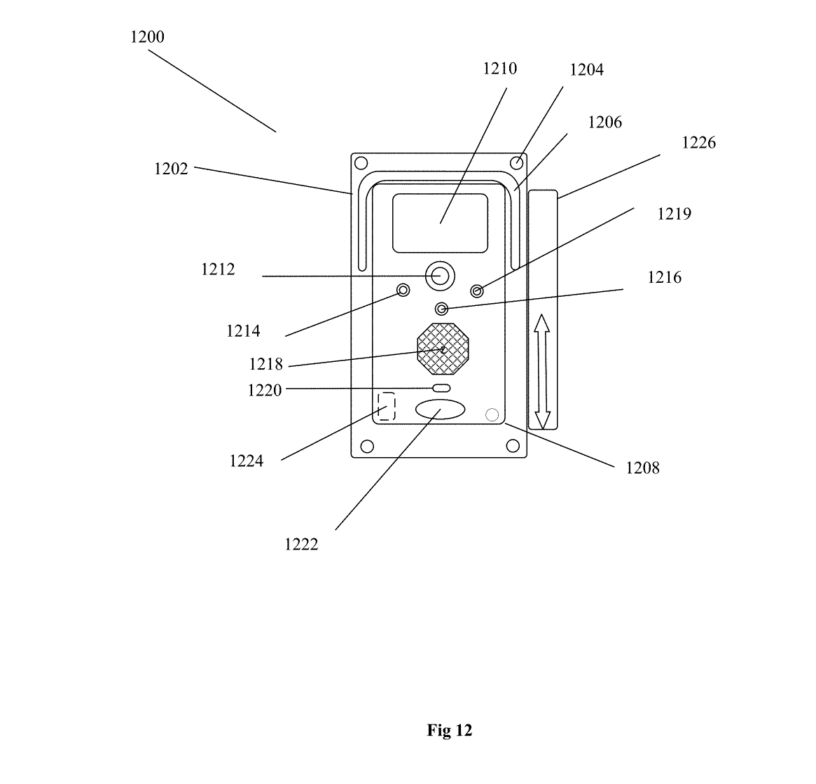

Another embodiment allows a customer 114 to directly purchase an article at the remote vending cage 200 without entering the structure 102. The customer 114 notifies the attendant 116 using a cage electronic module 1200 that they would like to purchase a new propane tank 504 and exchange an empty one. In this embodiment a card reader 1226 is integrated with the cage electronic module 1200 to allow a customer 114 to remotely purchase an exchange propane tank 504 by sliding their card through the credit card reader 1226 which may then notify the attendant 116 of the purchase of the propane tank 504 on their point of sale device. Additionally, a cash receiver or Apple Pay™ reader may replace the credit card reader 1226. The cage electronic module 1200 will be further described in FIGS. 12. Upon the purchase being verified and accepted by the attendant 116, they would then follow the same process as noted above in allowing the customer 114 remotely access to the remote vending cage 200 to remove and exchange a propane tank 504.

These two embodiments have dealt specifically with the purchase of propane tanks 504 at a business such as a convenience store. This remote cage vending system is adaptable to most any article that remains outside a business including but not limited to firewood, bags of ice and other articles that are typically kept outside because they are too large to fit within the structure 102, or where there is an apparent safety hazard associated with them such as with the propane tanks 504. It would apparent to one skilled in the art which article would be appropriate for the remote cage vending system 100.

The remote communications device 1208 may directly communicate with the remote monitor device 1100 wirelessly or wired through a voice communication path 110 and a non-voice communication path 112. These communication paths allow a customer 114 and attendant 116 to remotely converse concerning the transaction and also allows the attendant 116 to remotely open the remote cage 200 and visually monitor a customer 114 receiving the article and when the transaction is complete. Additionally, the remote monitor device 1100 may also communicate through a wireless network to the remote communication device 1208. The remote monitor device 1100 may communicate with the wireless router 106 which in turn routes the communication to remote communication device 1208. Where there is only one remote cage 200 direct communications may be desirable, however, where there were more than one remote cage 200 outside the structure 104, a networked system may be preferred. A remote cage vending system 100 using a wireless router 106 may be connected to a system server 108 that could perform functions such as tracking the remote cage 200 inventory, customer data associated with remote cage transactions, automatic ordering, and other pertinent data that would be apparent to one skilled in the art. The remote monitor device 1100 may also communicate through a wired connection to the remote communication device 1208 affixed to the remote vending cage 200, a wired router, and a system server 108.

One other aspect to the above described embodiments allows an attendant 116 to maintain the remote monitor device 1100 in its charging stand 102 if the attendant 116 remains at the service counter. However, if the attendant 116 needs to roam throughout the structure 102, the system is designed such that the remote monitor device 1100 may be removed from the charger stand 1002 and accompany the attendant 116 throughout the structure 102 where they can provide services to customers 114 outside without being at the service counter 104 at the time of the notification.

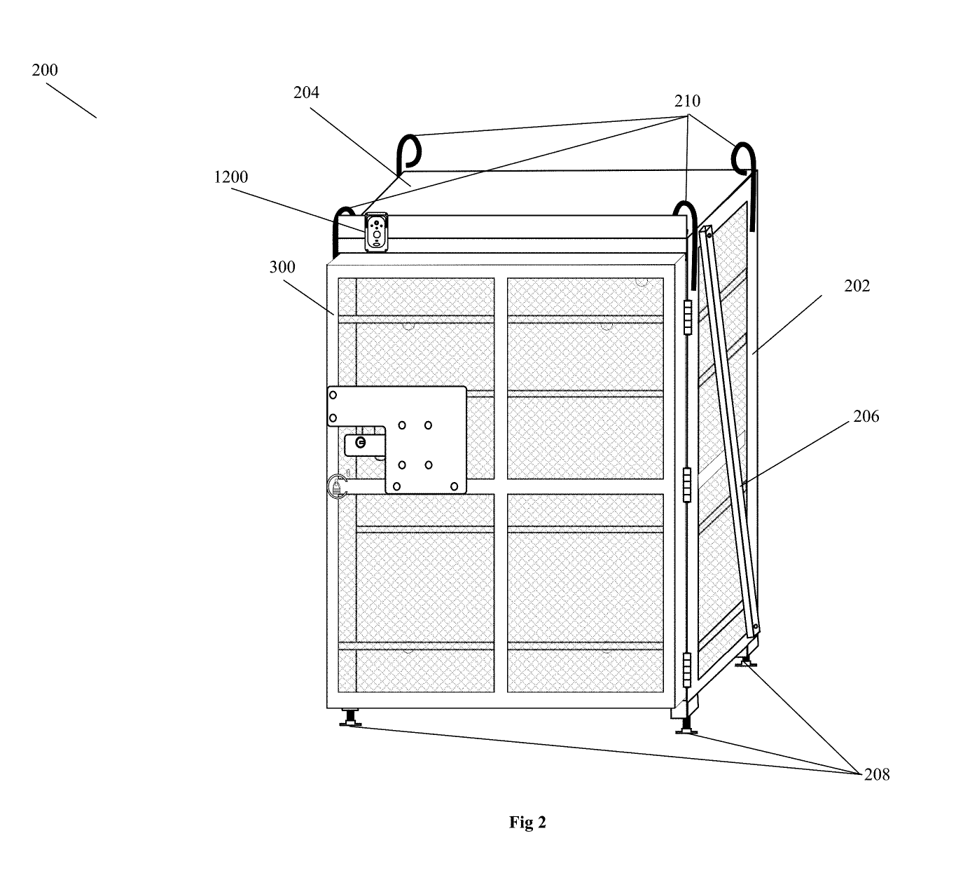

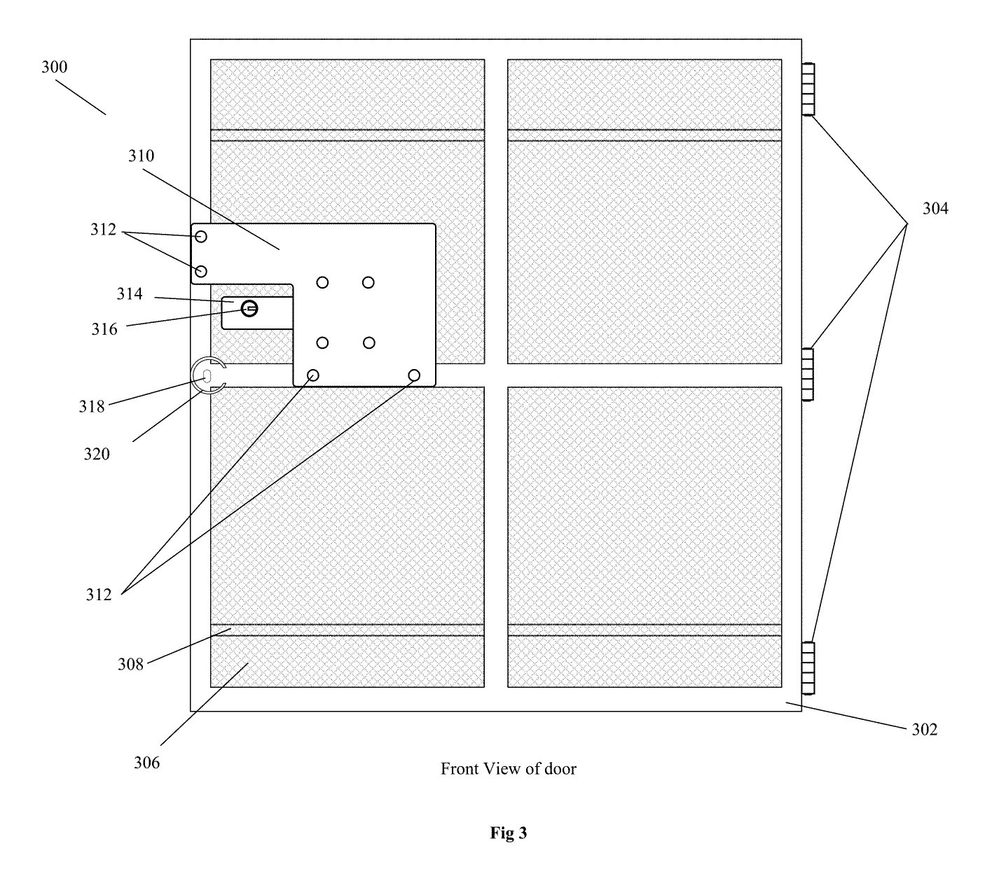

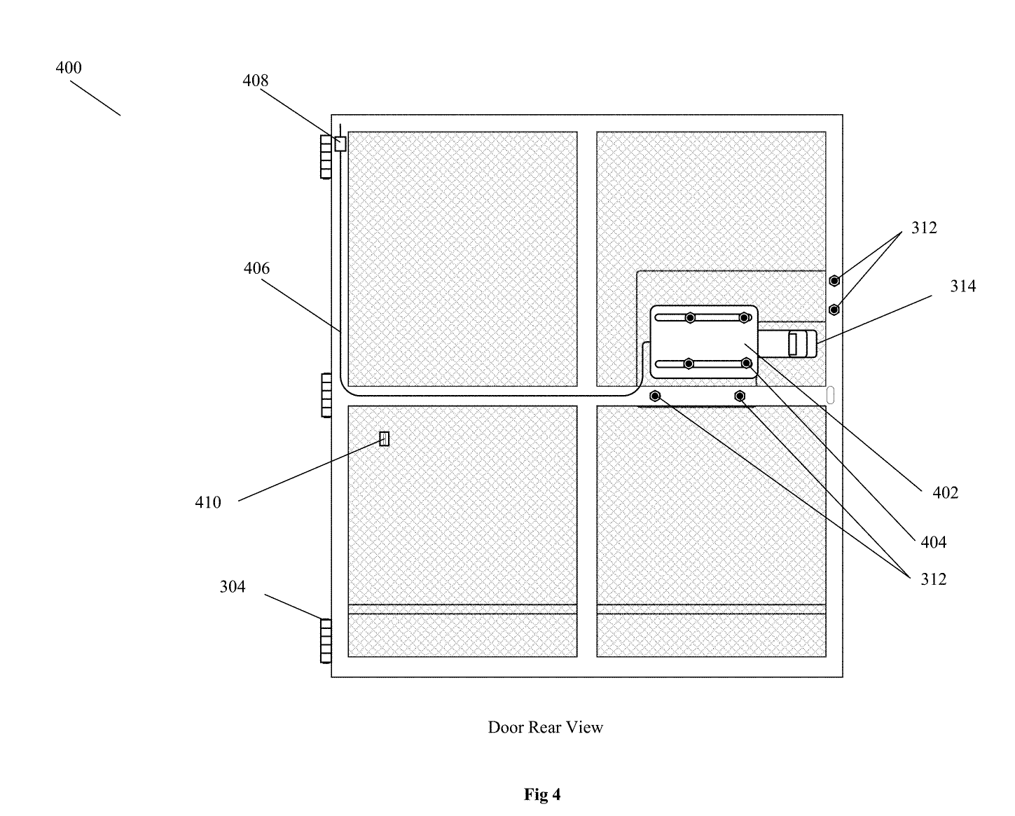

FIG. 2 is a perspective view of a remote vending cage 200. The remote vending cage 200 is typically placed outside the structure 102 due to safety concerns or limited space with inside the structure 102 for the articles. The remote vending cage 200 may comprise a cage structure 202, a cage top 204, a cage door 300, a cage structure brace 206, cage feet 208, cage lifting points 210, and a cage electronic module 1200. The hollow interior may include a cage structure 202, the cage top 204, cage shelves 502, and the cage door 300 wherein it provides for securely storing articles such as propane tanks 504 and firewood inside the remote cage 200. The remote cage 200 is preferably made from metal but may be constructed from other materials including but not limited to a metal alloy, fiberglass, plastic, carbon fiber, and wood. The door 300 will be further described in FIGS. 3 and 4.

The cage structure brace 206 may prevent the remote cage 200 from twisting and distorting while moving it to a desired location. Additionally, once the remote vending cage 200 is in its final position then the cage feet 208 are adjusted to level the remote cage 200. The cage feet 208 allows the remote vending cage 200 to be leveled forward and aft and side-to-side to prevent articles from unexpectedly exiting the front of the remote vending cage 200 when the cage door 300 is opened. The cage feet 208 are preferably threadedly attached to the remote vending cage 200 and adjusted by screwing the feet 208 up and down to acquire the appropriate level position. Once level, a brace 206 may provide the rigid structure to maintain the square of the remote cage 200 thus reducing gaps between the door 300 and remote cage 200 and preventing unauthorized access to the interior of the remote cage 200.

The remote vending cage 200 may be moved by attaching to the lifting points 210, a lifting device such as a forklift that would engage the lifting points 210 and allow the remote cage 200 to be moved to a desired location. The lifting points are preferably welded to the cage structure 202 but may use other affixation methods including, but not limited to, adhesives, bolts, screws, rivets, pins and anchors.

FIG. 3 is a view of the front of the remote vending cage door 300. The remote vending cage door 300 may consist of a door frame 302, hinges 304, protective screening 306, protective bars 308, a protective plate 310, protective plate mounting bolts 312, a remote locking system 314, a lock 316, a hasp 318 and padlock protection 320. The door frame 302 is preferably constructed from right angled metal to create a rectangular door to cover the opening of the remote cage 200 but may be constructed from other materials including but not limited to metal alloy, fiberglass, plastic, carbon fiber, and wood. In the openings of the door frame 302 protective screening 306 may be positioned and affixed to prevent unauthorized entry into the interior of the remote vending cage 200 while also allowing a customer 114 to view the contents of the remote vending cage 200. The protective screening is also affixed to the sides 600, 700 of the remote cage 200. The screening 306 provides some explosion resistance in the case of propane tank 504, where if an explosion were to occur, large portions of the propane tank 504 would remain while the escaping gasses would be allowed to exit the remote cage 200 without creating more projectiles. The protective bars 308 provides added structural rigidity to the door frame 302 while also adding another level of protection to the articles inside.

The door frame 302 is preferably attached to the remote vending cage 200 by the hinges 304. The hinges 304 may be affixed to the door frame 302 and the cage structure 202 by welding but other affixation methods including, but not limited to, adhesives, bolts, screws, rivets, pins and anchors may be used. In the current embodiment, three hinges 304 are utilized, however, the number of hinges 304 needed may be determined by the weight and the material used in the construction of the cage door 300. Additionally, a single continuous hinge 304 may also be used. The hinges 304 allow the remote vending cage door 300 to freely open and close without little effort and provide security to the contents inside.

The door 300 may be secured to the remote vending cage 200 by one or more locks. The remote locking mechanism 314 in this embodiment is preferably a door strike lock. Other remote locking mechanisms 314 include, but are not limited to door strike locks, magnetic locks, and electric deadbolts locks. The remote locking mechanism 314 in this embodiment may be mounted to the cage door 300 using a protective plate 310 and protective plate mounting bolts 312. This protective plate 310 allows for the remote locking mechanism 314 to be affixed to the door 300 and positioned to matedly attach to the locking pin 508. The plate 310 also prevents tampering with the remote locking mechanism 314 by unauthorized personnel. The remote locking mechanism 314 may be programmed to automatically lock when the door 300 returns to the closed position and it may also be programmed to delay locking for selected time period. Additionally, once the locking mechanism 314 is engaged the attendant 116 is notified the remote cage 200 is secure.

Additionally, there may be additional locking means attached to the cage door 300. The locking means may include but is not limited to combination, padlocks, key, keycard, keycode, password, biometric, radio frequency identification (RFID) and security token. In this embodiment, these locking means if engaged would prevent the remote locking mechanism 314 from functioning. In this embodiment, there are two additional locks. First, a key lock 316 is integrated with remote locking mechanism 314 such that when activated prevents the remote locking mechanism 314 from being actuated remotely, effectively taking the remote locking mechanism 314 out of the loop and requiring an attendant 116 to physically unlock the cage. This lock 316 allows a business that is not open 24 hours to secure the remote cage 200 during the non-business hours. Additionally, a hasp 318 allows a padlock staple 510 to protrude through the hasp 318 wherein a padlock may be attached to prevent unauthorized entry. Additionally, padlock protection 320 is positioned to increase difficulty for someone with bolt cutters attempting to cut the lock. These three locking systems described above allow the attendant 116 to provide multiple levels of security to the remote vending cage 200 based on the operating environment in which the remote vending cage 200 is located. They allow for varying degrees of access from remote to accompanied access through an attendant 116.

FIG. 4 is a view of the door from the rear 400. The rear view of the cage door 400 illustrates a remote locking mechanism retainer plate 402 and the associated retainer fasteners 404 for maintaining the locking mechanism 314 in position, remote lock wiring 406, a wiring retainer 408 and a retention device first attachment point 410. The remote locking mechanism retainer plate 402 is fixedly attached to the remote locking mechanism 314. The retainer plate 402 may be attached to the protective plate 310 using protective plate bolts 312. These bolts 312 may protrude through the retainer plate 402 slots and be secured in place using retainer fasteners 404. The retainer plate 402 may have slots that allow for horizontal adjustment of the remote locking mechanism 314 to correctly align the mechanism 314 with a locking pin 508. The retainer fasteners 404 includes but is not limited to nuts, washers, nylon nuts, and lock washers.

This view also provides an illustration of a preferred embodiment of the lock wiring 406 routing to the remote locking mechanism 314. Attached to the remote locking mechanism 314 is the lock wiring 406 that is routed such that it is protected by the door frame 302. The lock wiring 406 leaves the rear of the remote locking mechanism 314 and remains behind the protective plate 310 until it reaches the horizontal member of the door frame 302 at which time it may follow the door frame 302 until it reaches the vertical portion of the door frame 302. The lock wiring 406 may then follow the vertical member of the door frame 302 until it is secured in place by a wiring retainer 408 rigidly affixed to the cage door 300. The lock wiring 406 may be connected to a control box 518 mounted inside the remote vending cage 200. Additional wiring retainers 408 may be utilized in the routing of the lock wiring 406 as desired by one skilled in the art.

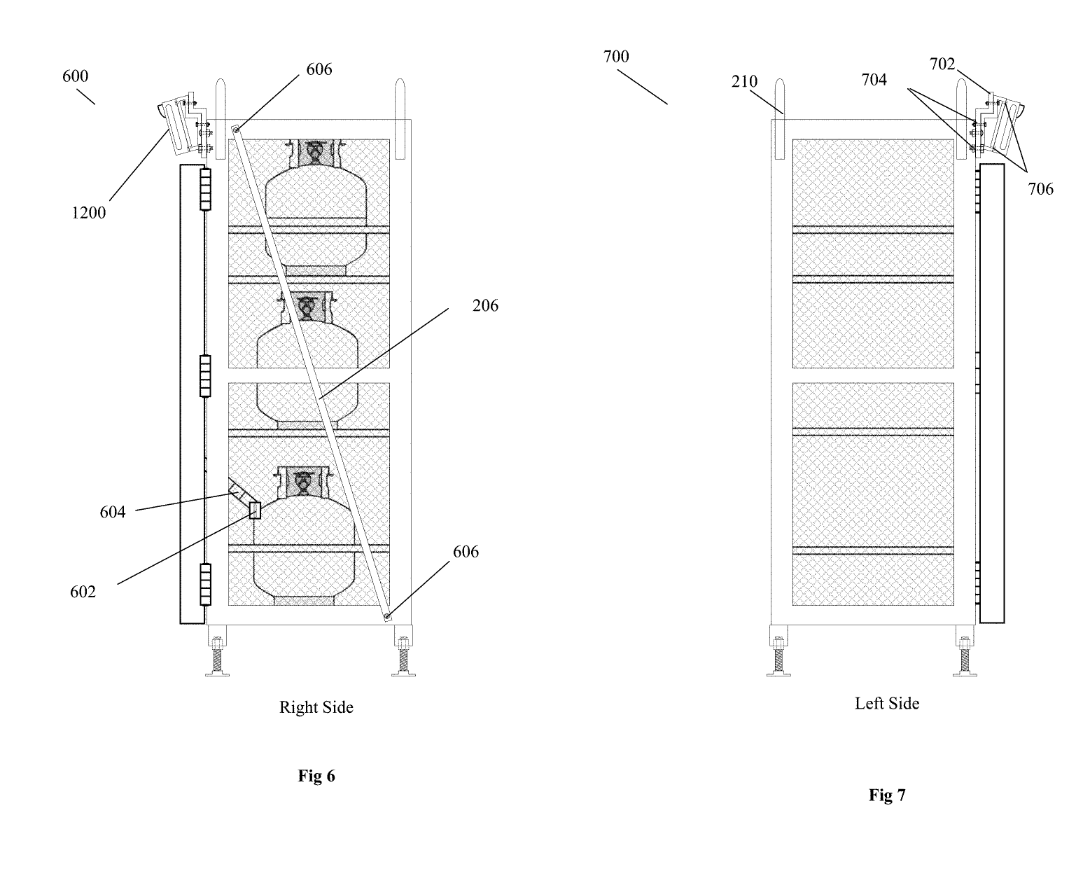

Also fixedly attached to the remote vending cage door 300 is a retention device first attachment point 410. This first attachment point 410 is the connecting point for automatically closing the cage door 300 and bringing the cage door 300 to its original position and engaging the locking pin 508 once a transaction between the attendant 116 and the customer 114 has concluded. This is further described below in FIG. 6.

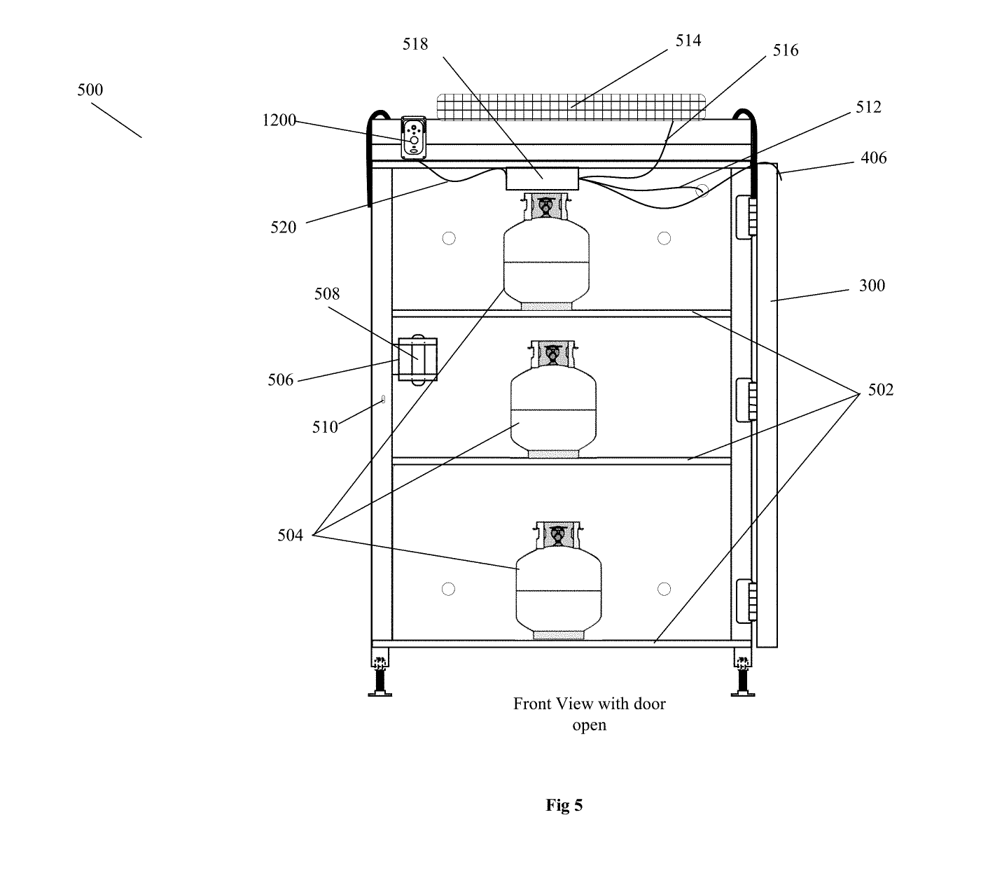

FIG. 5 is a detailed view of a remote vending cage with the front door fully opened 500. In this view, the internal parts a preferred embodiment of the remote vending cage 200 are illustrated. In this embodiment, the configuration preferably has three shelves 502 and for exemplary purposes propane tanks 504 that sit atop the shelves 502, a door strike pin mount 506, and a locking pin 508 that is matedly attached to the remote locking mechanism 314 and a padlock staple 510. In this current embodiment, there are three propane tanks 504, one sitting upon each shelf 502. Depending on the size of the remote vending cage 200, each one of those shelves 502 may hold multiple propane tanks 504 on a shelve 502 depending on the structural capacity of the shelves 502. One skilled in the art would be able to determine the capacity needed for the shelves 502 based on the articles to be dispensed. Other embodiments may have greater or fewer shelves 502 depending on the articles to be dispensed and the number of shelves 502 required would be apparent to one skilled in the art based on the size and weight of the articles. The shelves 502 may be adjustable or rigidly affixed to the interior of the remote cage 200.

The door strike pin mount 506 may rigidly place the locking pin 508 in a position to reengage the remote locking mechanism 314 once the retention device 604 has returned the cage door 300 to the locked position. As the cage door 300 moves to the locked position, the remote locking mechanism 314 reengages the locking pin 508 such that the remote locking mechanism 314 may be remotely actuated to unlock the cage door 300 once again. The remote cage detailed view 500 further illustrates the padlock staple 510. The padlock staple 510 maybe rigidly affixed to the remote cage 200. The padlock staple 510 may protrude through the cage door 300 at the hasp 318 wherein a padlock may be placed through the padlock staple 510 to prevent opening the cage door 300. In this configuration, the cage door 300 can no longer be operated open remotely.

This view 500 illustrates a cage electronic module 1200 may be powered by an internal battery 1224 or receive external DC power from a control box 518 via a DC power cable 520. The external DC power is supplied by a control box 518 that receives external power from a solar panel 514 via solar panel wiring 516, or other external power that may be the either AC or DC power via an external power cable 512. The control box 518 converts and conditions the external power to provide the required power for the cage electronic module 1200. The internal battery 1224 may be rechargeable wherein the rechargeable battery is then recharged by the external power source. The feed-through hole 902 preferably allows a connection to a standard outlet either with a standard 120-volt AC plug or through a DC converter connecting to a standard 120-volt AC plug. Additionally, the control box 518 routes the signals from the remote communications device 1208 to the remote locking mechanism 314 to actuate and unlock the door 300.

FIG. 6 is a detailed view of a remote vending cage's right side 600. This view illustrates a retention device 604, a cage retention device second attachment point 602 and the cage structure brace 206 affixed to a remote vending cage 200 by brace fasteners 606. In this embodiment, the retention device 604 is a spring and one end of a spring 604 is attached to a cage retention device second attachment point 602 affixed to the remote vending cage 200 and the opposite end of the spring 604 is attached to a retention device first attachment point 410. A spring 604 is preferably used to automatically return the door 300 to its closed position after allowing a customer 114 to retrieve an article from the interior of the remote vending cage 200 wherein the door strike 314 engages the locking pin 508. The spring may be replaced with other automatic closing devices including but not limited to mechanical, electromechanical, hydraulic and pneumatic.

Additionally, this view illustrates the cage structure brace 206 fixedly attached to the remote vending cage 200 utilizing the brace fasteners 606. They may be selected from fasteners including but not limited bolts, screws or other appropriate fasteners apparent to one skilled in the art.

FIG. 7 is a view of a remote vending cage's left side 700. This view illustrates the lifting points 210 and a remote communications device 1208 being affixed to a remote vending cage 200 by a remote device mounting bracket 702 and remote device mounting hardware 704. The remote communications device 1208 may be mounted in many locations on the remote vending cage 200. In a preferred embodiment, the remote communications device 1208 is mounted directly above the cage door 300 on the left side above the door strike 314. This mounting allows a customer 114 to be easily monitored once the remote vending cage 200 is remotely unlocked. The remote device mounting bracket 702 may be fixedly attached to the remote vending cage 200 by the remote device mounting hardware 704. The remote device mounting hardware 704 may include, but is not limited to, machine screws, nuts, bolts, screws and specialized security mounting hardware that is designed to prevent its removal. Additionally, the remote device mounting bracket 702 may be attached more permanently by methods, including but not limited to, welding and adhesives. The remote communications device 1208 may be rigidly affixed inside a protective enclosure 1202. The protective enclosure 1202 may be affixed to the remote device mounting bracket 702 using protective enclosure mounting hardware 706 that is placed through the protective enclosure mounting holes 1204 to secure the protective enclosure 1202 to the remote device mounting bracket 702. The protective enclosure mounting hardware 706 may include but is not limited to machine screws, nuts, bolts, screws and specialized security mounting hardware.

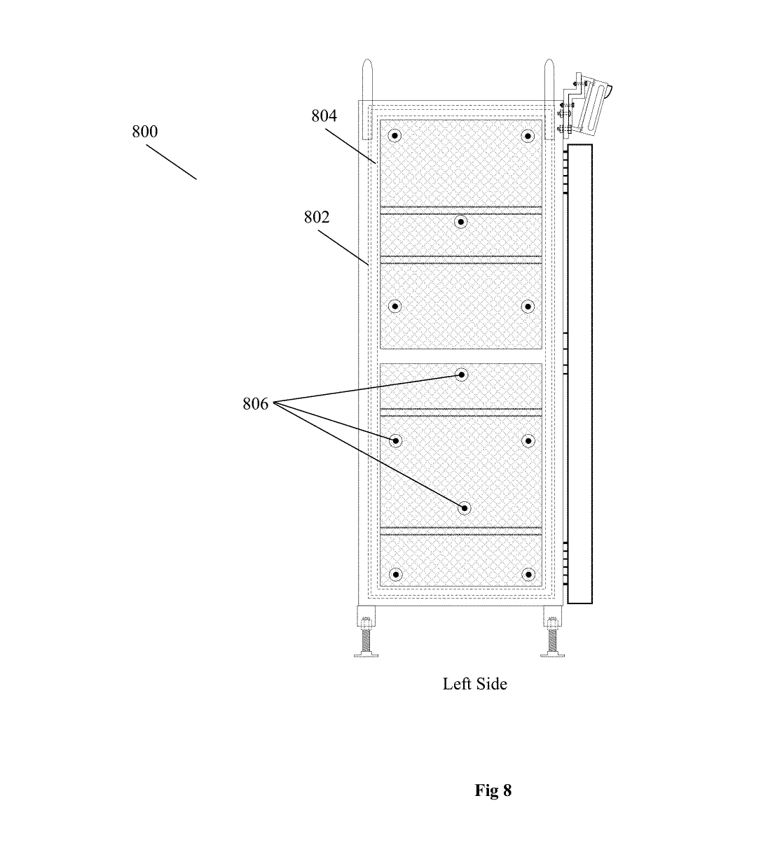

FIG. 8 is an exemplary view of the left side of a remote vending cage with insulation material installed 800. In one embodiment, the remote vending cage 200 may further comprise insulation or an insulating material 802 to help maintain a specific temperature of the articles inside such as ice or prevent direct sunlight and heating to articles such as propane tanks thereby minimizing an explosion hazard. In this embodiment, the insulating material 802 is placed throughout the interior of the remote vending cage 200 and is attached to the sides with an insulation perimeter attachment point 804 which includes but is not limited to a hook-and-loops, adhesives, and other types of affixation methods that allow for a continuous attachment around the sides of the remote vending cage 200 that would be apparent to one skilled in the art. This continuous attachment minimizes a temperature differential. Additionally, the insulating material 802 may have interior attachment points 806 which attach to the protective screening 306 to maintain the insulating material 802 in a desired position. The left-side view 800 is exemplary of the insulating material 802 as it would be affixed throughout the remote vending cage 200.

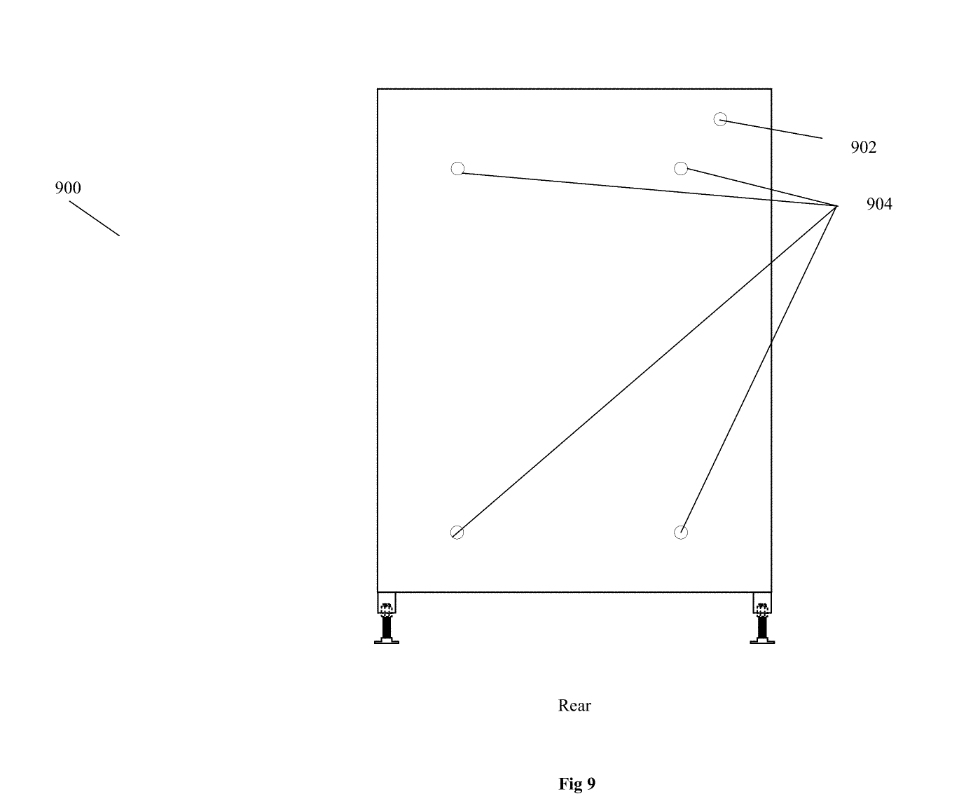

FIG. 9 is a remote vending cage detailed view from the rear 900. This view illustrates the electrical feed-through hole 902 that allows external power 512 from an power source outside of the remote vending cage 200 to be fed through the electrical feed-through hole 902 to the inside of the remote vending cage 200 to the control box 518.

Additionally, this view illustrates the remote cage mounting holes 904 wherein the remote vending cage 200 may be affixed to the structure 102. Affixing the remote vending cage 200 to a wall may prevent theft or the remote vending cage 200 from over turning in an event such as an earthquake or tornado. The remote vending cage 200 may be mounted to the wall of the structure 102 using mounting hardware that is specific to the wall type in which the remote vending cage 200 is being affixed.

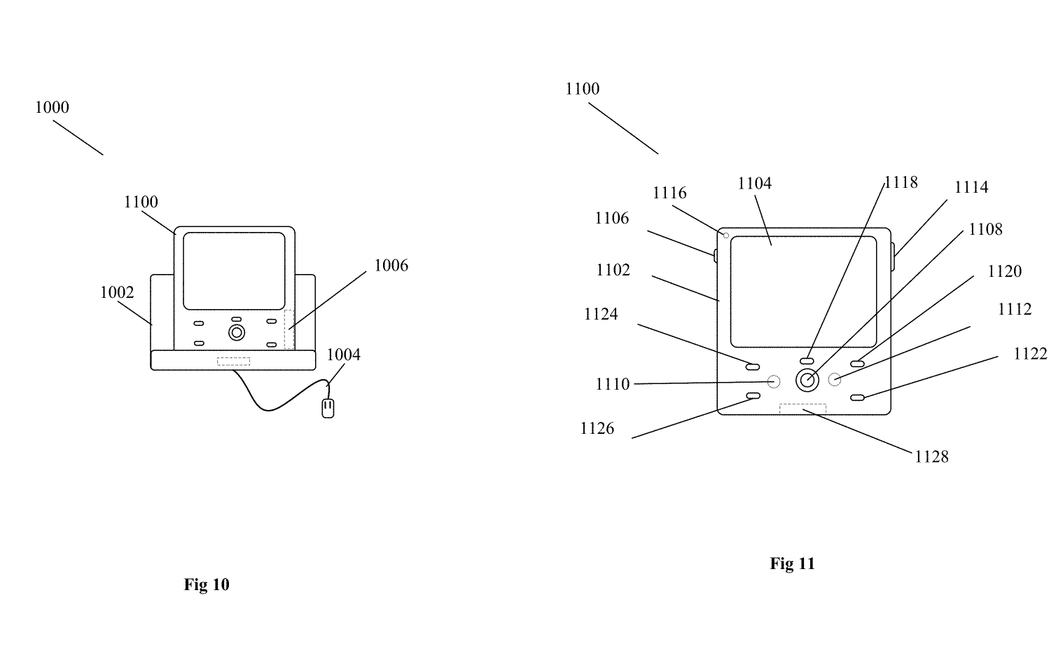

FIG. 10 is a view of a remote monitor device in its charging stand 1000. The remote monitor device 1100 is described in detail in FIG. 11. The remote monitor device 1100 may be used either in the charging stand 1002 which may be preferably stationed on the service counter 104 or may be handheld and used by an attendant 116 as they operate through the structure 102 performing their duties. While operating as a handheld device the remote monitor device 1100 may be powered by an internal battery 1006. Otherwise, when the remote monitor device 1100 is in the charging stand 1002 it may be powered externally. The charging stand 1002 may be connected to an AC power source such as a 120 volt wall outlet that charges the remote monitor device's battery 1006 when it is placed in the stand 1002 by an AC power adapter 1004.

FIG. 11 is a detailed view of a remote monitor device 1100. This embodiment may include a device case 1102, a display 1104, a power button 1106, a talk button 1108, a microphone 1110, a speaker 1112, a volume control 1114, a charging indicator 1116, a status indicator 1118, a view function 1120, and a charging port 1122. This remote monitor device 1100 may allow an attendant 116 to perform their duties and roam inside the structure 102 without being forced to stay behind the service counter 104. The elements described above may be placed inside a device case 1102 for ease of use and portability.

The attendant 116 applies power to the remote monitor device 1100 through the power button 1106. The remote monitor device 1100 allows an attendant 116 to communicate with a customer 114 visually through the display 1104 on the remote monitor device 1100 and through audio using the speaker 1112, microphone 1110, and the talk button 1108. The attendant 116 talks to a customer 114 through the microphone 1110 after pressing the talk button 1108 and speaking to the customer 114 wherein the attendant 116 can see the customer 114 on their display 1104 after selecting the view function 1120. The display may include, but is not limited to, an LCD and LED display. Additionally, the remote monitor device 1100 has a speaker 1112 with volume control 1114 that allows an attendant 116 to listen to a customer 114 and while they're speaking adjust the volume control 1114 to increase or decrease the volume of the customer 114 when the conditions warrant such adjustment. Additionally, a camera may be included in the remote monitor device 1100 to provide two-visual way communication.

Also illustrated in this embodiment of the remote monitor device 1100 is a status indicator 1118 that indicates the level of battery charge currently remaining in the remote monitor device 1100. This status indicator 1118 notifies the attendant 116 of the remaining power when the remote monitor device 1100 is not in its charging stand 1002. Once the remote monitor device 1100 is placed in the charging stand 1002 it is connected to the charging port 1122 on the remote monitor device 1100 to recharge the battery. A charging indicator 1116 indicates that the remote monitor device 1100 is currently charging. The remote monitor device 1100 may allow an attendant 116 to take and store pictures in the onboard memory.

In another embodiment, a remote monitor device 1100 includes a article inventory tracking means that allows the attendant 116 to interface with the system server 108 to view and track article inventory using a database. The tracking means may include RFID tags attached to the articles that communicate with the system server 108 and the remote monitor device 1100.

FIG. 12 is a detailed view of a cage electronic module 1200. The cage electronic module 1200 may include a projective closure 1202, an anti-glare shield, 1206, a remote communications device 1208, and a credit card reader 1226 and an external power source 520.

The remote communication device 1208 mounting is described in detail in FIG. 7. The protective cage 1202 protects the remote communication device 1208 from the environmental elements and also prevents tampering with the remote communication device 1208. An anti-glare shield 1206 for the display in camera may be integrated into the protective cage 1202 or may be a separate piece that is fixedly attached to the protective cage 1202. This anti-glare shield 1206 helps shield the effects of the sun on the camera and display.

The remote communication device 1208 interface means is selected from switches, buttons, sensors, keypads, and touchscreens. In a preferred embodiment the remote communications device 1208 may comprise a display 1210, a camera 1212, lights 1214, an infrared (IR) sensor 1216, a low battery status indicator 1220, a call button 1222, an internal battery 1224, a speaker 1218 and a microphone 1219. The microphone 1219 and speaker 1218 allow the customer 114 to communicate with the attendant 116. The customer 114 pushes the call button 1222 on the communications device 1208 to notify the attendant 116 on the remote monitor device 1100. The notification may be by audio or visual que to the attendant 116 or both. The audio cues may be programmable tones or voices. Once the attendant 116 is notified, they can then respond to the customer 114 using the remote monitor device 1100 wherein they can press the talk button 1108 and converse with the customer 114 through the microphone 1110 and listen to the customer's 114 response through the speaker 1112 on the remote monitor device 1100. While talking to the customer 114, the attendant 116 may visually monitor the customer 114 through the remote communication device camera 1212 and the remote monitor device display 1104. In another embodiment the customer 114 may be able to visually monitor the attendant 116 through a camera on the remote monitor device 1100 and a display 1210 on the remote communications device 1208.

The remote communications device 1208 may also utilize lighting 1214 to include infrared (IR) and regular LED type lights for operation at in lowlight conditions and at night. Additionally, the remote communications device 1208 may employ a passive IR sensor that allows the attendant 116 inside the structure 102 to be immediately notified when an IR sensor 1216 detects motion near the remote vending cage 200. The attendant 116 could use the remote monitor device 1100 to view the area on the display 1104.

In another embodiment, a credit card reader 1226 is integrated with the remote communications device 1208 thereby allowing a customer 114 to approach the remote vending cage 200, talk to the attendant 116 and upon her direction could then slide a credit card through the credit card reader 1226 or place the card in close proximity to provide payment for the articles inside the remote vending cage 200. Once the payment has been received from the customer then the attendant 116 could remotely open the door of the remote vending cage 200 by activating the remote locking mechanism 314 which would then allow the customer 114 to access the articles inside the remote vending cage 200.

Having thus described the invention, I claim:

1. An apparatus for dispensing articles to a user comprising:
a. at least one cage having—
i. a plurality of walls defining a hollow interior therein adapted to receive a plurality of articles,
ii. at least one door with a lock, the door defined in a wall and adapted to allow an article to pass therethrough, and
iii. a lock closing means for automatically engaging the lock;
b. at least one cage electronic module having—
i. a power source,
ii. at least one cage communication means for communicating with a remote monitoring device,
iii. at least one camera,
iv. an cage interface means for receiving user inputs,
v. at least one cage notification means for transceiving notifications, and
vi. at least one lock opening means allowing an attendant to remotely release the lock; and
c. at least one remote monitoring device in communication with the cage electronic module having—
i. power supply,
ii. at least one remote communication means for communicating with at least one cage electronic module,
iii. at least one visual display for receiving a video feed from at least one camera associated with at least one cage,
iv. at least one remote device interface means for receiving attendant inputs; and
v. at least one remote notification means for tranceiving notifications,
whereby, after payment is made by a user, a user can notify an attendant that they are ready to have at least one article dispensed from at least one cage, and an attendant release a lock remotely allowing a user to gain access to articles, and an attendant can visually monitor the dispensing remotely, after which the lock automatically re-engages.

2. The apparatus of claim 1 where a retention device automatically returns the door to the secured position.

3. The apparatus of claim 2, where the retention device selected from a group including at least one of mechanical, electromechanical, hydraulic, and pneumatic.

4. The apparatus of claim 1, where each cage is comprised of a material selected from a group including at least one of metal, metal alloy, plastic, fiberglass, carbon fiber, and wood.

5. The apparatus of claim 1, where each article inside each cage is visible from outside of each cage.

6. The apparatus of claim 1, where each cage is explosion resistant.

7. The apparatus of claim 1, where each cage is insulated.

8. The apparatus of claim 1, where each cage includes at least one shelf affixed inside each cage.

9. The apparatus of claim 1, where the cage electronic module power source is selected from internal or external.

10. The apparatus of claim 9, where the internal power source is a battery.

11. The apparatus of claim 9, where the battery is rechargeable.

12. The apparatus of claim 11, where the battery is recharged using photovoltaics.

13. The apparatus of claim 9, where the external power is selected from AC or DC.

14. The apparatus of claim 1, where the communication means is selected from wired or wireless.

15. The apparatus of claim 1, where the cage electronic module interface means is selected from switches, buttons, sensors, keypads, and touchscreens.

16. The apparatus of claim 1, where the notification means is selected from audio and visual.

17. The apparatus of claim 16 where the audio is selected from programmable tones and voice.

18. The apparatus of claim 1, where a second locking means for securing the door is provided.

19. The apparatus of claim 18, where the second locking means is selected from combination, padlocks, key, keycard, keycode, password, biometric, RFID and security token.

20. The apparatus of claim 1, where the cage electronic module has a display.

21. The apparatus of claim 1, where the cage electronic module is adapted to accept payment.

22. The apparatus of claim 21, where the payment is selected from card swipe, chip card, proximity systems, or currency receiver.

23. The apparatus of claim 1, where the remote monitoring device includes a camera.

24. The apparatus of claim 1, where the remote monitoring device includes memory for storing pictures.

25. The apparatus of claim 1, where the remote monitoring device includes an article inventory tracking means for accounting for article inventory.

26. The apparatus of claim 25, where the tracking means is RFID tags.

27. The apparatus of claim 25, where the remote monitoring device is in communication with a database adapted to track article inventory.

28. A method for remotely dispensing articles comprising:
a. providing the apparatus of claim 1 for dispensing articles
b. paying for the desired articles;
c. notifying an attendant that user has arrived at an cage and is ready to receive the articles;
d. verifying the user is the one who paid for the articles;
e. unlocking the door of the cage remotely;
f. notifying the user that the cage is unlocked;
g. the user removing the articles while being monitored on video by the attendant;
h. closing the door; and
i. locking the door,
whereby a user may pay for desired articles in a locked cage outside of a store, and an attendant may remotely provide the user access to the articles and verify proper dispensing of same without the attendant leaving the store.

29. The method of claim 28, wherein the door is programmed to automatically lock.

30. The method of claim 29, wherein the automatic lock is delayed for a selected time period.

31. The method of claim 30, wherein the attendant is notified when the door is locked.

32. An apparatus for dispensing articles to a user comprising:
a. an cage having—
i. a plurality of walls defining a hollow interior therein adapted to receive a plurality of articles,
ii. at least one wall where each article inside each cage is visible from outside of each cage,
iii. at least one shelf, for holding a plurality of articles within the cage,
iv. at least one door with a lock, the door defined in a wall and adapted to allow an article to pass therethrough, and
v. a lock closing means for automatically engaging the lock;
b. at least one cage electronic module having—
i. a power source,
ii. at least one cage communication means for communicating with a remote monitoring device,
iii. at least one camera,
iv. an cage interface means for receiving user inputs,
v. at least one cage notification means for transceiving notifications, and
vi. at least one lock opening means allowing an attendant to remotely release the lock; and
c. at least one remote monitoring device in communication with the cage electronic module having—
i. a power supply,
ii. at least one remote communication means for communicating with at least one cage electronic module,
iii. at least one visual display for receiving a video feed from at least one camera associated with at least one cage,
iv. at least one remote device interface means for receiving attendant inputs,
v. at least one remote notification means for transceiving notifications,
whereby, after payment is made by a user, a user can see an article through at least one wall, notify an attendant that they are ready to have at least one article dispensed from at least one cage, on at least one shelf, and an attendant release a lock remotely allowing a user to gain access to articles, and an attendant can visually monitor the dispensing remotely, after which the lock automatically re-engages.
